(19) United States
(12) Patent Application Publication
(10) Pub. No.: US 2012/0133761 A1
(43) Pub. Date: May 31, 2012

(54) UNEVEN AREA INSPECTION SYSTEM

(75) Inventors: Gyoung Il Cho, Seoul (KR); Hye Young Kim, Jeonbuk (KR); Cheong Soo Seo, Seoul (KR)

(73) Assignees: ANGSTROM, INC., Seongnam (KR); STEREO DISPLAY, INC., Anaheim, CA (US)

(21) Appl. No.: 12/957,325

(22) Filed: Nov. 30, 2010

(51) Int. Cl. H04N 7/18

(52) U.S. Cl. 348/92; 348/E07.085

(57) ABSTRACT

An uneven area inspection system of the present invention comprises a patterned panel comprising a panel, wherein the panel have a surface on which a pattern is formed, an object with at least one surface reflecting light from the patterned panel, an imaging unit optically coupled to the patterned panel and the object and configured to capture the image of the patterned panel reflected by the surface of the object, and an image processing unit configured to process the captured image to compare the pattern in the patterned panel and the pattern in the captured image. The object can have uneven area and the uneven area of the object is inspected by comparing the pattern in the patterned panel and the pattern in the captured image.

### FIELD OF THE INVENTION

The present invention relates to the inspection system in general, and more specifically to the uneven area inspection system using pattern reflection.

### BACKGROUND OF THE INVENTION

A touch screen panel is composed of several thin layers and can have various types of defects including particle, stain, scratch, and uneven area (e.g. dent) at any layer. The touch screen panel having some of these defects has to be removed before used in the application devices. Conventionally, the touch screen panel has been inspected manually with human eyes. The manual inspection by human eyes is, however, subject to many errors depending on the training and experience level of each individual inspector and also can be very slow and costly. Especially, detecting the uneven areas on the layers of the touch screen panel is extremely difficult even under the microscope if not impossible since the depth amount of the dent is usually very small. Those dents, however, can still cause problems in touch screen panel operation and have to be detected.

FIG. 1 shows a conventional method to detect dents in a touch screen panel 11. Light 12 is reflected on the surface of the touch screen panel 11 so that the human 13 can inspect the surface of the touch screen panel.

### SUMMARY OF INVENTION

The uneven area inspection system of the present invention are contrived to provide accurate, simple, cost effective uneven area inspection system capable of indentifying the uneven areas and determining geometric properties of the identified uneven areas.

An uneven area inspection system of the present invention comprises a patterned panel comprising a panel, wherein the panel have a surface on which a pattern is formed, an object with at least one surface reflecting light from the patterned panel, an imaging unit optically coupled to the patterned panel and the object and configured to capture an image of the patterned panel reflected by the surface of the object, and an image processing unit configured to process the captured image to compare the pattern in the patterned panel and the pattern in the captured image. The surface of the object can have uneven area. The surface of the object is inspected for the uneven area by comparing the pattern in the patterned panel and the pattern in the captured image.

The panel of the patterned panel can be made of transparent material, translucent material, or opaque material.

The uneven area inspection system can further comprise an illumination unit configured to illuminate the patterned panel to enhance the quality of the image captured by the imaging unit.

The illumination unit can be disposed such that the patterned panel is located between the object and the illumination unit. In another word, the patterned panel is illuminated from the back side of the patterned panel. This configuration is desirable for the transparent panel and the translucent panel.

The illumination unit can be disposed such that the object and the illumination unit are located at the same side of the patterned panel. This configuration is desirable for the translucent panel and the opaque panel.

The patterned panel can have arbitrary patterns including, but not limited to, vertical stripes, horizontal stripes, and lattices.

The object can be opaque, translucent, or transparent.

The surfaces of the object reflecting the light from the patterned panel can be a top surface of the object and a bottom surface of the object, wherein the bottom surface of the object reflects the light from the patterned panel that passes the top surface of the object.

The imaging unit captures the images of the patterned panel reflected by a plurality of the surfaces of the object simultaneously in order to inspect the surfaces of the object for the uneven area.

The object can have a plurality of layers reflecting the light from the patterned panel, wherein each layer can have one or more of the surfaces reflecting the light from the patterned panel. Each layer can have the uneven area. The imaging unit captures the images of the patterned panel reflected by the surfaces of the layers simultaneously in order to inspect the surfaces of the layers for the uneven area.

Conventional cameras and microprocessors can serve as the imaging unit and the image processing unit. Also, human eyes and brain can serve as the imaging unit and the image processing unit, as well. By observing the captured image of the patterned panel reflected by the object, the uneven area in the surface of the object can be readily determined.

### DESCRIPTION OF THE FIGURES

These and other features, aspects and advantages of the present invention will become better understood with reference to the accompanying drawings, wherein:

FIG. 1 shows a conventional method to detect dents in a touch screen panel 11;

FIGS. 2a and 2b are schematic diagrams illustrating one embodiment of an uneven area inspection system using pattern reflection;

FIGS. 3a-3c illustrate how the pattern in the captured image is affected by being reflected by a surface with uneven area;

FIGS. 4a and 4b show schematic diagrams illustrating embodiments of the present invention equipped with illumination unit; and

FIGS. 5a and 5b shows schematic diagrams illustrating an embodiment of uneven area inspection system for an object having a plurality of surfaces.

FIGS. 6a and 6b shows schematic diagrams illustrating an embodiment of uneven area inspection system for an object having a plurality of surfaces in a plurality of layers.

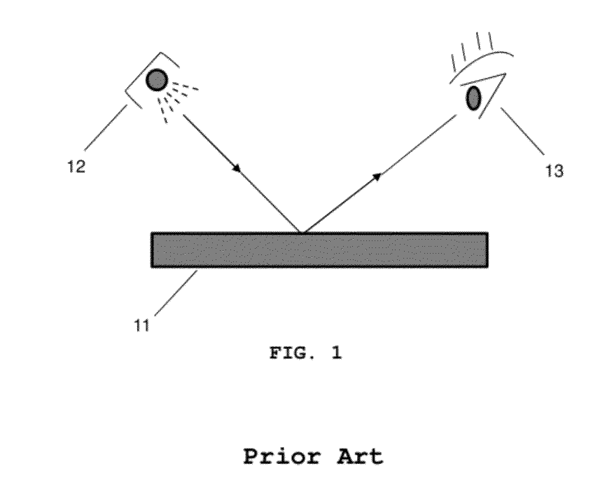

### DETAILED DESCRIPTION OF THE INVENTION

The present invention will now be described in detail with reference to embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

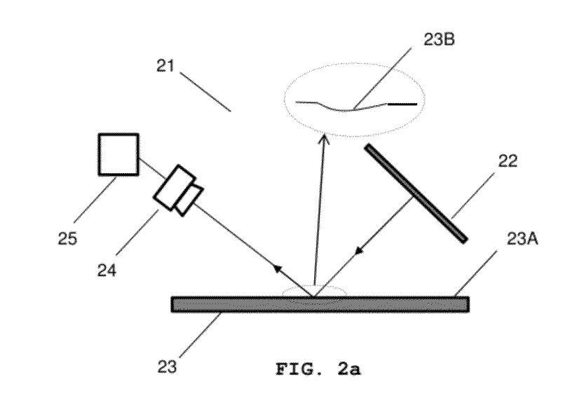

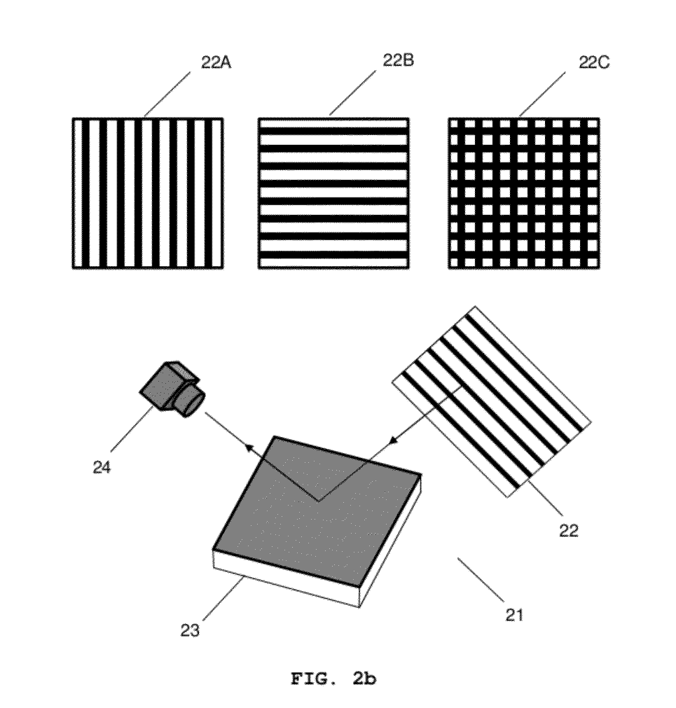

FIGS. 2a and 2b are schematic diagrams illustrating one embodiment of an uneven area inspection system using pattern reflection. An uneven area inspection system 21 of the present invention comprises a patterned panel 22, an object 23, an imaging unit 24, and an image processing unit 25. The patterned panel 22 comprises a panel having a surface, on which a pattern is formed. The panel can be made of transparent material, translucent material, or opaque material. The panel can have various patterns including, but not limited to, vertical stripes 22A, horizontal stripes 22B, and lattices 22C as shown in FIG. 2b. The object 23 has at least one surface 23A to be inspected for possible existing uneven area 23B. The object 23 is configured to reflect light from the patterned panel 22. The object 23 can be transparent, translucent, or opaque. The imaging unit 24 is optically coupled to the patterned panel 22 and the object 23 and is configured to capture the image of the patterned panel 22 reflected by the surface 23A of the object 23. The image processing unit 25 is configured to process the captured image to compare the pattern in the patterned panel 22 and the pattern in the captured image.

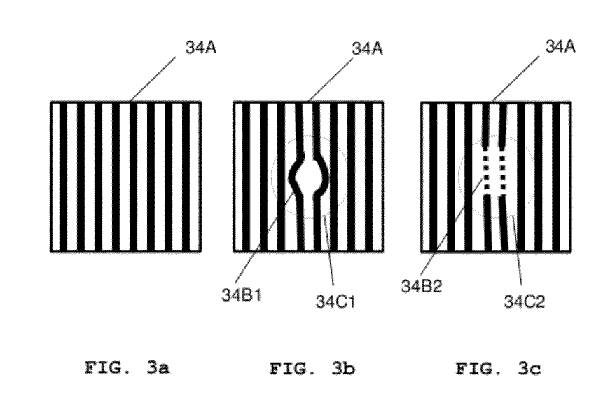

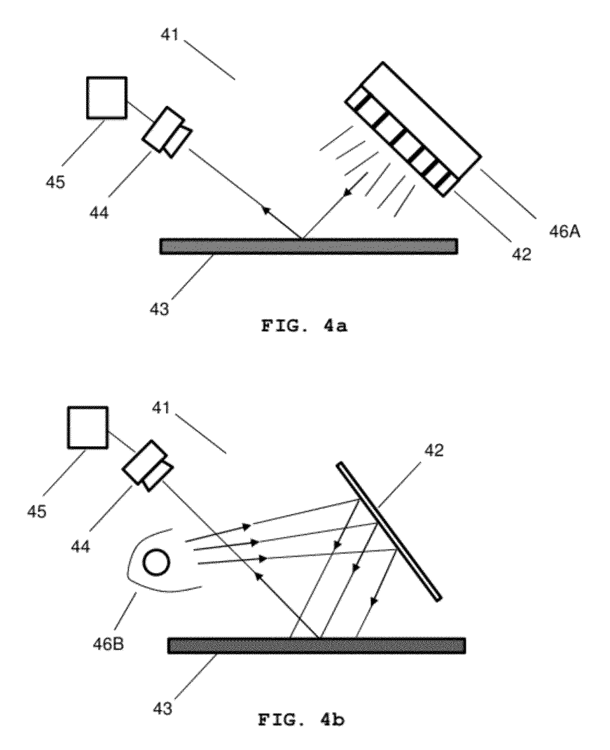

FIGS. 3a-3c illustrate how a pattern in the captured image is affected by being reflected by a surface with uneven area. When a considered surface of the object is substantially flat without uneven area, the pattern in the captured image 34A will be a just mirror image of the pattern in the patterned panel as shown in FIG. 3a. If the uneven area exists, however, the pattern in the captured image 34A will not be a simple mirror image of the pattern in the patterned panel anymore. FIGS. 3b and 3c show how a stripe pattern is affected by being reflected by a surface with uneven area. The straight line in the patterned panel can become curved 34B1 when reflected by a surface with uneven area as shown in FIG. 3b. Similarly, the straight line in the patterned panel can become blurred 34B2 when reflected by a surface with uneven area as shown in FIG. 3c. Since the image of a pattern reflected by a surface with uneven area becomes distorted while the image of the pattern reflected by even surface remain the same, existence and locations of the uneven areas 34C1 and 34C2 become apparent in the captured image 34A. The uneven area 34C1 and 34C2 in the object can be determined by simply comparing the pattern in the patterned panel and the pattern in the captured image.

Referring back to FIG. 2, conventional cameras and microprocessors can serve as the imaging unit 24 and the image processing unit 25. This configuration is desirable for an automatic uneven area inspection system. Also, human eyes and brain can serve as the imaging unit 24 and the image processing unit 25. By observing the captured image of the patterned panel 22 reflected by the object 23, the uneven area 23B in the surface of the object 23 can be readily determined. This configuration is desirable for a manual uneven area inspection system.

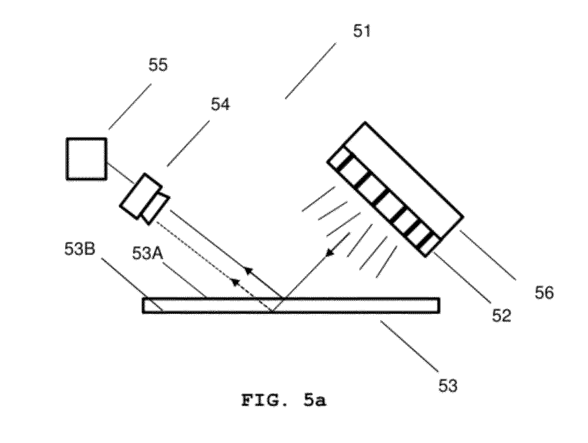

The uneven area inspection system can further comprise an illumination unit configured to illuminate the patterned panel to enhance the quality of the image captured by the imaging unit. FIGS. 4a and 4b show embodiments of the present invention equipped with illumination unit. An uneven area inspection system 41 of the present invention comprises a patterned panel 42, an object 43, an imaging unit 44, an image processing unit 45, and an illumination unit 46A, 46B.

The illumination unit 46B can be disposed such that the patterned panel 42 is located between the object 43 and the illumination unit 46A as shown in FIG. 4a. In another words, the patterned panel 42 is illuminated from the back side of the patterned panel 42. This configuration is desirable for the transparent panel and the translucent panel.

The illumination unit can 46B be disposed such that the object 43 and the illumination unit 46B are located at the same side of the patterned panel 42 as shown in FIG. 4b. This configuration is desirable for the translucent panel and the opaque panel.

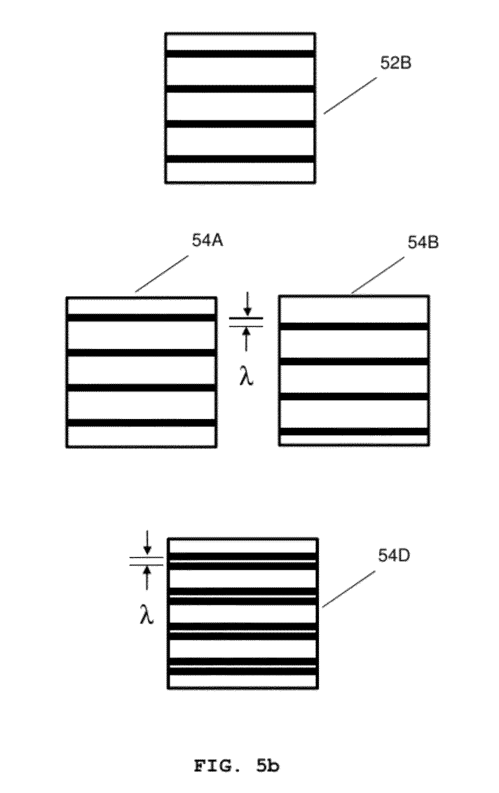

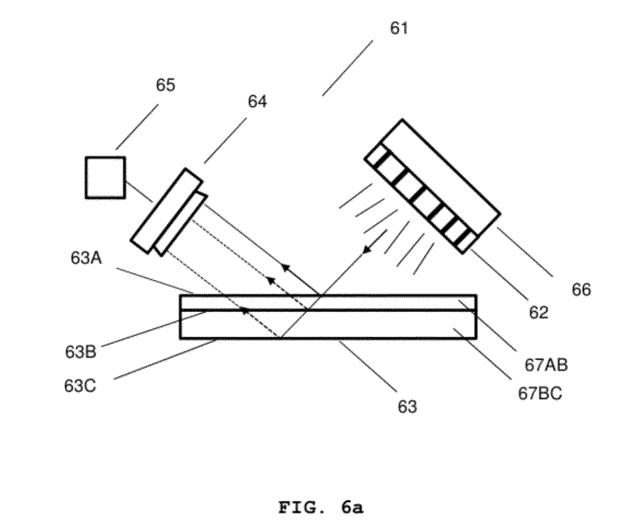

FIGS. 5a and 5b show an embodiment of uneven area inspection system for an object having a plurality of surfaces. An uneven area inspection system 51 of the present invention comprises a patterned panel 52, an object 53, an imaging unit 54, and an image processing unit 55. The system 51 can further comprise an illumination unit 56. When the object 53 is transparent or translucent, the object 53 can have a top surface 53A and a bottom surface 53B reflecting the light from the patterned panel 52. The bottom surface 53B of the object 53 reflects the light from the patterned panel that passes the top surface 53A of the object 53. The bottom surface 53B of the transparent or translucent object 53 can have uneven area also. In this case, the imaging unit 54 can be further configured to capture an image of the patterned panel 52 reflected by the bottom surface 53B of the object 53 to determine the uneven area on the bottom surface 53B of the object 53. Since the uneven area on the top surface 53A of the object 53 and the uneven area on the bottom surface 53B of the object 53 can be determined simultaneously, the top and bottom surfaces 53A, 53B of the object 53 can be inspected at the same time.

FIG. 5b illustrates the pattern 52B in the patterned panel 52, the captured image 54A of the patterned panel 52 reflected by the top surface 53A of the object 53, the captured image 54B of the patterned panel 52 reflected by the bottom surface 53B of the object 53, and the captured image 54D of the patterned panel 52 reflected by the top surface 53A of the object 53 and the bottom surface 53B of the object 53, simultaneously, wherein the captured image 54D of the patterned panel 52 reflected by the bottom surface 53B of the object 53 is shifted by λ, from the captured image 54A of the patterned panel 52 reflected by the top surface 53A of the object 53. The image processing unit 55 is configured to identify the uneven areas and the surfaces that the uneven areas are located by using distance information between the surfaces 53A, 53B and the pattern shift amount λ.

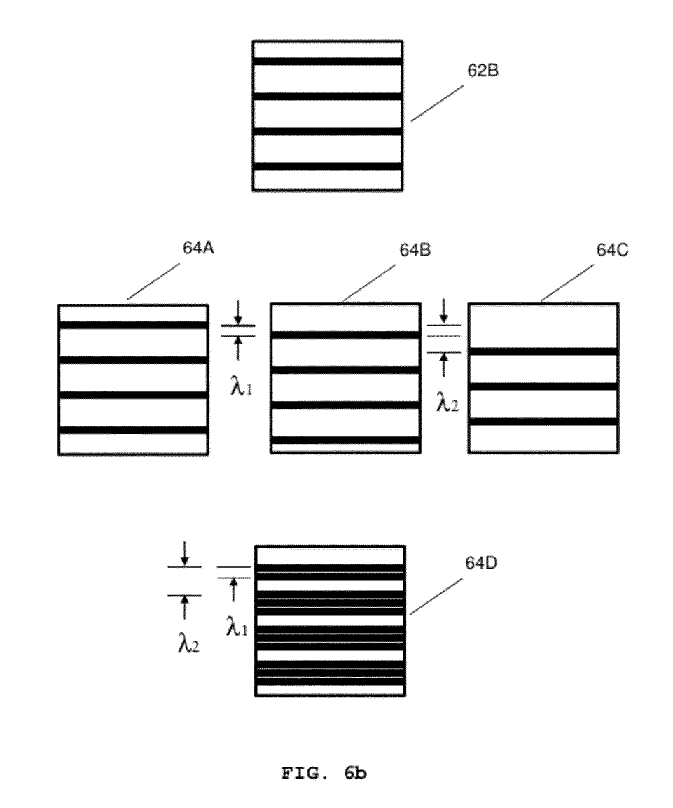

FIGS. 6a and 6b show an embodiment of uneven area inspection system for an object having a plurality of layers. An uneven area inspection system 61 of the present invention comprises a patterned panel 62, an object 63, an imaging unit 64, and an image processing unit 65. The system 61 can further comprise an illumination unit 66. The object 63 has a plurality of layers 67AB, 67BC reflecting the light from the patterned panel 62. Each layer 67AB, 67BC can have one or more of the surfaces 63A, 63B, 63C reflecting the light from the patterned panel. These surfaces 63A, 63B, 63C in the layers 67AB, 67BC can have the uneven area. The imaging unit 64 captures the images of the patterned panel 62 reflected by the surfaces 63A, 63B, 63C of the layers 67AB, 67BC simultaneously in order to inspect the surfaces 63A, 63B, 63C for the uneven area. The uneven areas at the different surfaces 63A, 63B, 63C of the layers 67AB, 67BC can be detected simultaneously.

FIG. 6b illustrates the pattern 62B in the patterned panel 62, the captured images 64A, 64B, 64C of the patterned panel 62 reflected by the surfaces 63A, 63B, 63C of the layers 67AB, 67BC, and the captured image 64D of the patterned panel 62 reflected by all the surfaces 63A, 63B, 63C of the layers 67AB, 67BC of the object 63, simultaneously, wherein the captured image 64B of the patterned panel 62 reflected by the second surface 63B of the object 63 is shifted by λ₁ from the captured image 64A of the patterned panel 62 reflected by the surface 63A and the captured image 64C of the patterned panel 62 reflected by the third surface 63C of the object 63 is shifted by λ₂ from the captured image 64A of the patterned panel 62 reflected by the surface 63A. The image processing unit 65 is configured to identify the uneven areas and the surfaces that the uneven areas are located by using distance information between the surfaces 63A, 63B, 63C and the pattern shift amounts λ₁, λ₂.

What is claimed is:

1. An uneven area inspection system comprising:
a) a patterned panel comprising a panel, wherein the panel have a surface on which a pattern is formed;
b) an object with at least one surface reflecting light from the patterned panel;
c) an imaging unit optically coupled to the patterned panel and the object and configured to capture an image of the patterned panel reflected by the surface of the object; and
d) an image processing unit configured to process the captured image to compare the pattern in the patterned panel and the pattern in the captured image;
wherein the surface of the object is inspected for uneven area by comparing the pattern in the patterned panel and the pattern in the captured image.

2. The uneven area inspection system of claim 1, wherein the panel is made of opaque material.

3. The uneven area inspection system of claim 1, wherein the panel is made of translucent material.

4. The uneven area inspection system of claim 1, wherein the panel is made of transparent material.

5. The uneven area inspection system of claim 1, further comprising an illumination unit configured to illuminate the patterned panel.

6. The uneven area inspection system of claim 5, wherein the illumination unit is disposed such that the patterned panel is located between the object and the illumination unit.

7. The uneven area inspection system of claim 5, wherein the illumination unit is disposed such that the object and the illumination unit are located at the same side of the patterned panel.

8. The uneven area inspection system of claim 1, wherein the patterned panel has a stripe pattern.

9. The uneven area inspection system of claim 1, wherein the patterned panel has a lattice pattern.

10. The uneven area inspection system of claim 1, wherein the patterned panel has an arbitrary pattern.

11. The uneven area inspection system of claim 1, wherein the object can be opaque.

12. The uneven area inspection system of claim 1, wherein the object can be translucent.

13. The uneven area inspection system of claim 1, wherein the object can be transparent.

14. The uneven area inspection system of claim 1, wherein the surfaces of the object reflecting the light from the patterned panel are a top surface of the object and a bottom surface of the object, wherein the bottom surface of the object reflects the light from the patterned panel that passes the top surface of the object.

15. The uneven area inspection system of claim 1, wherein the imaging unit captures the images of the patterned panel reflected by a plurality of the surfaces of the object simultaneously in order to inspect the surfaces of the object for the uneven area.

16. The uneven area inspection system of claim 1, wherein the object comprises a plurality of layers, wherein each layer can have one or more of the surfaces reflecting the light from the patterned panel.

17. The uneven area inspection system of claim 1, wherein the imaging unit captures the images of the patterned panel reflected by the surfaces of the layers simultaneously in order to inspect the surfaces of the layers for the uneven area.

18. The uneven area inspection system of claim 1, wherein the imaging unit is human eyes and the image processing unit is human brain.

19. The uneven area inspection system of claim 1, wherein the imaging unit is a camera and the image processing unit is a microprocessor.

20. The uneven area inspection system of claim 19, wherein the uneven area inspection system is automated.
